(19) United States
(12) Patent Application Publication
(10) Pub. No.: US 2009/0281867 A1
(43) Pub. Date: Nov. 12, 2009

(54) System and Method to Service Medical Equipment

(75) Inventors: Crispian Sievenpiper, Waukesha, WI (US); Adrian F. Warner, Delafield, WI (US); Richard Frowein, Waukesha, WI (US)

Correspondence Address: GE HEALTHCARE;c/o FLETCHER YODER, PC, P.O. BOX 692289, HOUSTON, TX, 77269-2289, US

(73) Assignee: General Electric Company, Schenectady, NY (US)

(21) Appl. No.: 12/115,680

(22) Filed: May 6, 2008

(51) Int. Cl. G06F 17/30

(52) U.S. Cl. 705/10

(57) ABSTRACT

A system and method to facilitate service delivery to a client is provided. In one embodiment, a system may collect service event data corresponding to one or more failure modes from a population of devices and analyze the service event data in accordance with a reliability growth model to detect a trend in occurrences of the one or more failure modes. The system may also predict future client demand for service of the population of devices attributable to the one or more failure modes based at least in part on the detected trend, and generate a report indicating at least one of the detected trend or the predicted future client demand.

### BACKGROUND

The invention relates generally to the field of service delivery and, more specifically, to a system and method to facilitate efficient management of such service delivery.

In a variety of industrial, commercial, medical, and research contexts, various pieces of equipment may be employed on a day-to-day basis to accomplish or facilitate the work being performed at a facility. In many instances, the facility may rely upon a third party to provide service for some or all of the equipment at the site to ensure that the equipment remains operational and available. For example, in an industrial setting, production equipment or computer resources that are in operation in a continuous or near-continuous manner may be serviced by an off-site party that provides servicing as needed or requested. Similarly, hospitals, clinics, and research facilities may utilize another party to service some or all of the diagnostic, monitoring, and/or imaging equipment at a site so that the equipment remains available where and when it is needed.

Such an arrangement, however, may impose burdens on the service provider that are difficult to overcome in an efficient and cost-effective manner. For example, a service provider may utilize a combination of remote personnel and field personnel to provide service to a variety of clients. Additionally, a service provider or a supplier may often maintain a broad inventory of parts to allow replacement of malfunctioning components of serviced systems. While maintaining relatively high resource levels, including staffing levels, inventory levels, and the like, may allow a service provider to more quickly meet service needs as they arise, it will be appreciated that the maintaining of higher levels of resources may generally result in higher costs for the service provider. Thus, the allocation of resources at levels in excess of that actually needed to service a given system or, more generally, to provide service expected by a client, may be inefficient and unnecessarily add to the operating expenses of a service provider. Conversely, maintaining an insufficient level of resources may prevent timely service delivery and could lead to client dissatisfaction with the service provider.

### BRIEF DESCRIPTION

There is a need for a system and method to efficiently manage service delivery that accounts for, among other things, variation in device reliability. The subject matter described herein is operable to address the needs and concerns described above. Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

An embodiment of the present invention includes a system including a memory device having a plurality of routines stored therein. The system may also include a processor configured to execute the plurality of routines stored in the one or more memory devices. In one embodiment, the plurality of routines may include a routine to collect service event data corresponding to one or more failure modes from a population of medical devices disposed at one or more healthcare facilities, and a routine to analyze the service event data in accordance with a reliability growth model to detect a trend in occurrences of the one or more failure modes. The plurality of routines may also include a routine to output a report including at least one of the following: an indication of the detected trend, an indication of a predicted future client demand for service of the population of devices attributable to the one or more failure modes based at least in part on the detected trend, or a recommended resource allocation based at least in part on the predicted future client demand.

According to another embodiment, a method may include collecting service event data corresponding to one or more failure modes from a population of devices disposed at one or more client locations. The method may also include analyzing the service event data, via a computer, in accordance with a reliability growth model to detect a trend in occurrences of the one or more failure modes, and predicting future client demand for service of the population of devices attributable to the one or more failure modes based at least in part on the detected trend. Additionally, the method may include outputting a report including at least one of an indication of the detected trend or an indication of the predicted future client demand.

According to yet another embodiment, a manufacture may include a computer-readable medium having executable instructions stored thereon. The executable instructions may include instructions to collect data from one or more medical facilities, as well as instructions to analyze the data in accordance with a reliability growth model to detect a trend in the data. Further, the executable instructions may also include instructions adapted to output a report including at least one of the following: an indication of the detected trend, an indication of predicted future service demand based at least in part on the detected trend, or a suggested resource allocation based at least in part on the predicted future service demand.

Various refinements of the features noted above may exist in relation to various aspects of the subject matter described herein. Further features may also be incorporated in these various aspects as well. These refinements and additional features may exist individually or in any combination. For instance, various features discussed below in relation to one or more of the illustrated embodiments may be incorporated into any of the above-described aspects of the subject matter of the application alone or in any combination. Again, the brief summary presented above is intended only to familiarize the reader with certain aspects and contexts of the present subject matter without limitation to the claimed subject matter.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of one embodiment of an exemplary processor-based device or system in accordance with the subject matter described herein;

FIG. 2 depicts an embodiment of networked system of medical devices and a data processing system in accordance with the subject matter described herein;

FIG. 3 is a flow diagram of an embodiment of a service delivery management method in accordance with the subject matter described herein; and

FIG. 4 is a graph of an example of cumulative device failures over time, which are logarithmically plotted and representative of data that may be used by the data processing system of FIG. 2 to detect trends in such data in accordance with the subject matter described herein.

### DETAILED DESCRIPTION

One or more specific embodiments of the subject matter will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Moreover, while the term “exemplary” may be used herein in connection to certain examples of aspects or embodiments of the presently disclosed subject matter, it will be appreciated that these examples are illustrative in nature and that the term “exemplary” is not used herein to denote any preference or requirement with respect to a disclosed aspect or embodiment. Further, any use of the terms “top,” “bottom,” “above,” “below,” other positional terms, and variations of these terms is made for convenience, but does not require any particular orientation of the described components.

As generally noted above, certain embodiments of the presently disclosed subject matter may include a system and a method that facilitate efficient management of service delivery to a client. In some embodiments, the method includes collecting service event data and analyzing such data to detect a data trend. In various embodiments, the service event data may include any data capable of being analyzed for trends that may, in turn, be used for providing service to a client, including, but not limited to, system failure data, failure mode data, service records, patient data, or the like. In one exemplary embodiment, the data trend is a reliability trend with respect to a device, which may indicate an increase or decrease in reliability of the device or an associated component over a given time period. Based on such a trend, future client demand for servicing of the device or the component may be predicted, and resources may be allocated based on the prediction, as discussed in greater detail below.

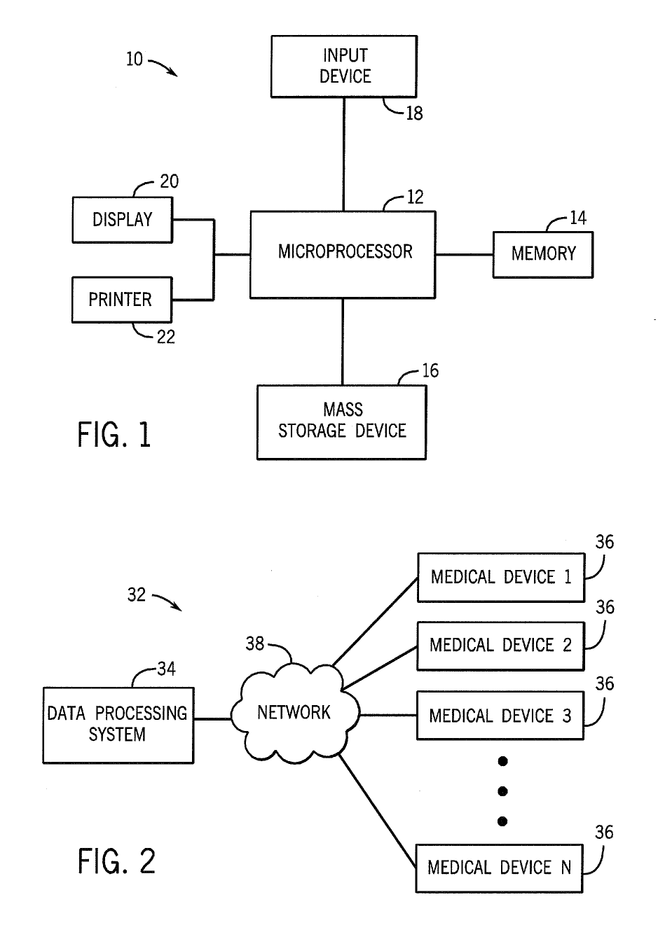

Turning now to the drawings, and referring first to FIG. 1, an exemplary processor-based system 10 for use in conjunction with the present technique is depicted. In one embodiment, the exemplary processor-based system 10 is a general-purpose computer, such as a personal computer, configured to run a variety of software, including software implementing all or part of the present technique. Alternatively, in other embodiments, the processor-based system 10 may comprise, among other things, a mainframe computer, a distributed computing system, or an application-specific computer or workstation configured to implement all or part of the present technique based on specialized software and/or hardware provided as part of the system. Further, the processor-based system 10 may include either a single processor or a plurality of processors to facilitate implementation of the presently disclosed functionality.

Referring to FIG. 1, an embodiment of a processor-based system 10 includes a microcontroller or microprocessor 12, such as a central processing unit (CPU), which executes various routines and processing functions of the system 10. For example, the microprocessor 12 may execute various operating system instructions as well as software routines configured to effect certain processes and stored in or provided by a manufacture including a computer readable-medium, such as a memory 14 (e.g., a random access memory (RAM) of a personal computer) or one or more mass storage devices 16 (e.g., an internal or external hard drive, a solid-state storage device, CD-ROM, DVD, or other storage device). Various software routines or instructions for implementing the functionality described herein may be stored in a single computer-readable medium, or may be collectively stored in a plurality of computer-readable media, in which a subset of such routines are stored in a first computer-readable medium while the remaining routines are stored in one or more other computer-readable media (e.g., a multi-disc software set or a distributed processing system). As such, any reference herein to a memory device or computer-readable medium having a set of routines or instructions stored thereon is intended to encompass the aforementioned embodiments, including those in which the routines or instructions are distributed across multiple devices or media. In addition, the microprocessor 12 processes data provided as inputs for various routines or software programs, such as data provided as part of the present technique in computer-based implementations.

Such data may be stored in, or provided by, the memory 14 or mass storage device 16. Alternatively, such data may be provided to the microprocessor 12 via one or more input devices 18. The input devices 18 may include manual input devices, such as a keyboard, a mouse, or the like. In addition, the input devices 18 may include a network device, such as a wired or wireless Ethernet card, a wireless network adapter, or any of various ports or devices configured to facilitate communication with other devices via any suitable communications network, such as a local area network or the Internet. Through such a network device, the system 10 may exchange data and communicate with other networked electronic systems, whether proximate to or remote from the system 10.

Results generated by the microprocessor 12, such as the results obtained by processing data in accordance with one or more stored routines, may be provided to an operator via one or more output devices, such as a display 20 and/or a printer 22. Based on the displayed or printed output, an operator may request additional or alternative processing or provide additional or alternative data, such as via the input device 18. Communication between the various components of the processor-based system 10 may typically be accomplished via a chipset and one or more busses or interconnects which electrically connect the components of the system 10. In one embodiment the exemplary processor-based system 10 can be configured to facilitate service delivery for one or more systems, such as medical systems, as discussed in greater detail below with respect to FIGS. 2-4.

As also discussed in greater detail below, the processor based-system 10 may be configured to facilitate analysis of service event data and the performance of service rules associated with functional systems, as well as management of service delivery with respect to such systems. Embodiments of such functional systems may include a medical system (e.g., an imaging system, a diagnostic system, a monitoring system, or the like), although data and rules pertaining to non-medical systems (e.g., security systems, industrial systems, etc.) may also or instead be analyzed in full accordance with the present techniques.

FIG. 2 illustrates an embodiment of a networked system 32 in accordance with the subject matter described herein. A data processing system 34 can be configured to communicate with a plurality of medical devices 36 via a network 38. The data processing system 34 may include the processor based system 10 illustrated in FIG. 1, although it is noted that the data processing system 34 may include various components or systems different than, or in addition to, those illustrated in FIG. 1 in full accordance with the present technique. Additionally, the network 38 may include one or more of a local area network (LAN), a wide area network (WAN), such as the Internet, as well as various other components that facilitate communication, including switches, routers, servers or other computers, network adapters, communications cables, and so forth, as would be appreciated by one skilled in the art.

An embodiment of the medical devices 36 may include imaging systems of one or more modalities, such as magnetic resonance (MR), computed tomography (CT), positron emission tomography (PET), X-ray, tomosynthesis, or the like. It should be appreciated, however, that the presently disclosed technique may also or instead be used in association with patient monitors, diagnostic devices, other medical resources, or some combination of these devices and systems. Such other medical resources may include, among other things, data storage or processing systems, such as computer workstations, servers, picture archiving and communication systems (PACS), radiological information systems (RIS), and so forth. While the embodiment of the system 10 can be described in combination with a plurality of medical devices, the system 10 can be in combination with non-medical devices.

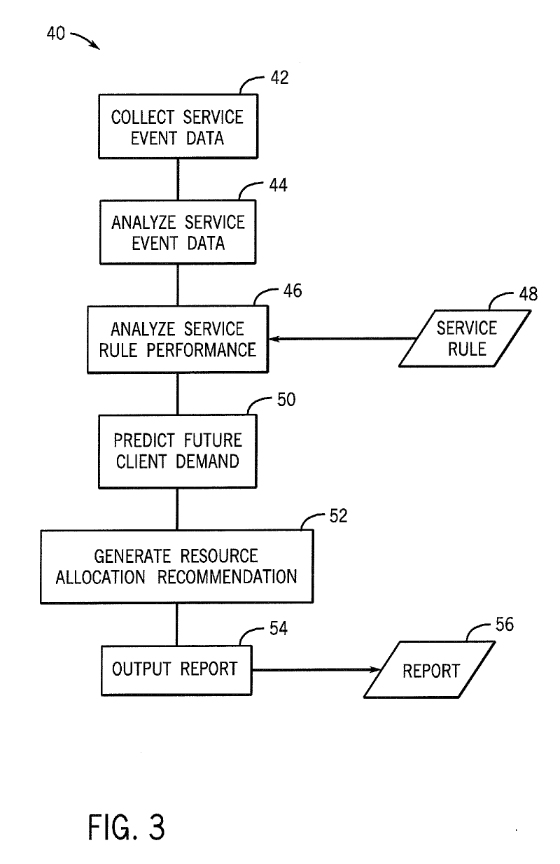

As illustrated in FIG. 3, an embodiment of the data processing system 34 may be configured to perform one or more steps of an exemplary method 40 to facilitate service delivery with respect to the medical devices 36. Some or all of the steps performed by the data processing system 34 may be performed as part of a software-based and/or spreadsheet-based application having routines adapted to effect the steps described herein. In other embodiments, however, the steps performed by the system 34 may be performed via application-specific hardware or circuitry configured to perform such steps. Additionally, various steps described with respect to the method 40 may be performed in any suitable order in full accordance with the present technique, and need not be performed in the order described below.

An embodiment of the method 40 includes a step 42 of collecting service event data from a plurality of devices, such as the medical devices 36. The service event data may be collected in various ways. For example, in one embodiment, the data processing system 34 may receive the service event data from medical devices 36 configured to automatically transmit such data to the data processing system 34 via the network 38. In other embodiments, the data processing system 34 may be configured to request service event data from the medical devices 36 via the network 38, an operator may manually input the service event data into the data processing system 34 based on information from a client or service technician, or the data may be collected in any other suitable fashion.

The service event data may include a wide array of data relevant to service delivery for a device or client, such as a medical device or healthcare institution. For example, the service event data may include occurrences of failure modes with respect to one or more medical devices 36 used by a client, such as medical devices deployed in a healthcare facility or in the field. In some embodiments, service rules may be generated and deployed in conjunction with the medical devices 36 and may be configured to detect failure mode occurrences and to provide an indication of such an occurrence to facilitate servicing of the medical devices 36. Device failures may, of course, be associated with particular failure modes without such service rules based on information received via input from a client or service technician. It should also be noted that, while certain service rules may be triggered upon the occurrence of a failure mode, other service rules may be adapted to detect and indicate a predicted device failure that is likely to occur in the future unless the device is serviced. Such predictive indications allow pre-emptive servicing of the device by a service provider before device failure, thus minimizing downtime of the device and inconvenience to the owner of the device. Accordingly, the service event data may also include data pertaining to predictions of future failure mode occurrences.

The embodiment of the method 40 may also include a step 44 of analyzing the service event data. In some embodiments, the service event data may be treated as a reliability growth problem and analyzed via any suitable mathematical model, such as a Duane model or a Crow-AMSAA model. By analyzing the service event data via such models, the data processing system 34 may detect changes in reliability of the medical devices 36, or an associated component, over time.

For example, performance of a medical device or a component, such as an X-ray tube or intravenous (IV) pump, may be analyzed in accordance with a Crow-AMSAA non-homogeneous Poisson process (N.H.P.P.) model. It will be appreciated that such a model includes various assumptions, including that failure arrival times are independent from one another and are identical within a time segment, and that reliability of the device or component may change during testing. In one embodiment, the failure intensity of the device or component may be approximated by a Weibull function:

f(t)=λβT^{β-1},

where λ is a scale parameter and β equals one minus the reliability growth rate of the device or component. Consequently, a value of β greater than one can suggest a negative reliability growth rate or trend (i.e., reliability of the device or component is declining over time), while a value of β less than one may indicates improved reliability of the device or component over time.

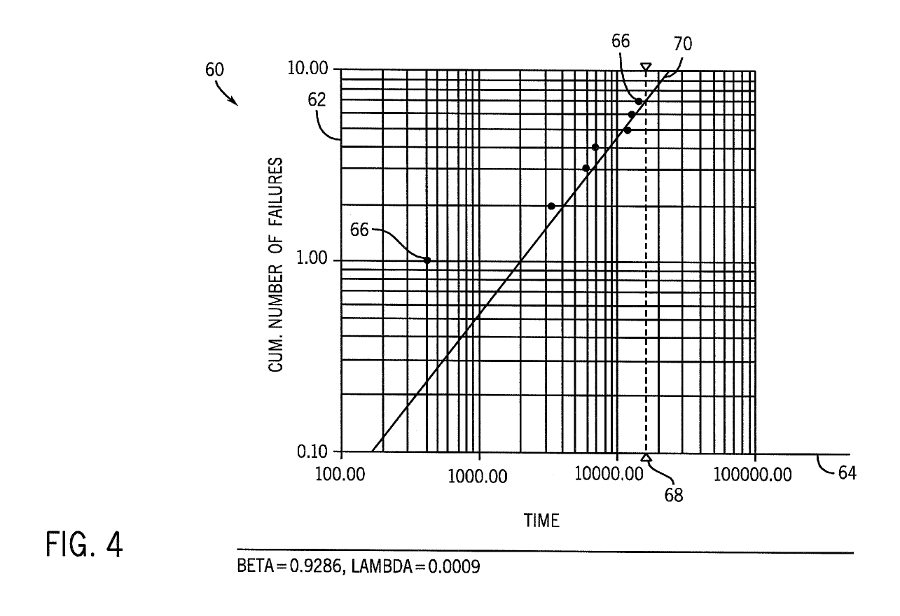

Using this model, the cumulative number of failures over time may be considered to derive the value of β. For example, and as shown in FIG. 4, the cumulative number of failures versus time may be plotted on a logarithmic scale. One skilled in the art can appreciate that β can be generally equal to the slope of a linear interpolation of the data points. The logarithmic graph of FIG. 4 is provided merely for illustrative purposes with respect to data that may be analyzed by the data processing system 34, and such analysis may be performed computationally without actually plotting the data in a human-readable graph or a logarithmic scale. Additionally, in various embodiments, the cumulative number of failures may include all device or component failures, or may include only a subset of such failures associated with one or more selected failure modes. Still further, the cumulative number of failures may include actual failures, predicted failures, or some combination of the two.

Consider such modeling with respect to a particular component, such as an IV pump common to a population of medical treatment devices. Such a population may include any number of devices, although it will be appreciated that a greater number of devices may result in increased confidence levels and lower margins of error with respect to interpolations or estimates derived from the analyzed data. As shown in FIG. 4, an example of the cumulative number of IV pump failures can be plotted along the vertical axis 62 on logarithmic scale with respect to the cumulative operational time of the IV pumps, as indicated along the horizontal axis 64. The cumulative time along the axis 64 may be provided in any desired unit of measurement, such as operational hours, days, or the like, and may be computationally accounted for through variation of λ in the Weibull function noted above.

Assuming the plotted time can be measured in days, graph 60 illustrates that the first IV pump failure for the modeled time sample can occur at approximately 400 days of cumulative device operational time, while other IV pump failures can occur at approximately 3,200 days, 6,000 days, 7,000 days, 12,000 days, 13,000 days, and 15,000 days. A linear best-fit curve 70 may be interpolated from the data points 66 and used for various purposes, including to calculate the value of β, to calculate the frequency of future pump failures, or to compare the failure rates of a device or component over the given time sample relative to that of another time sample, for instance. As generally noted above, a value of β greater than one can indicate a reliability of the IV pump (or other component or system) can be declining over time, while a value of β less than one can indicate improved reliability of the IV pump or component over time. Consequently as illustrated in FIG. 4, a determination that β=0.9286, can suggest that the reliability of the IV pump or other component has improved over the time sample analyzed.

Returning to FIG. 3, the embodiment of the method 40 can also include a step 46 of analyzing the performance of a deployed service rule 48. For example, the improvement or decline in the reliability of a system or component, as determined through analysis of the service event data, may be correlated with the service rule 48. For instance, service event data collected following generating and deploying a service rule may be compared to that collected prior to such deployment. In this instance, improvement in the reliability of a component following the deployment of a service rule associated with that component (e.g., detecting or predicting a failure mode occurrence) may generally suggest that the service rule 48 can have a positive impact on the reliability of the IV pump or component, while the lack of improvement may suggest that a given service rule 48 may not be operating to improve reliability of the component or system. As described above, the method 40 can include tracking the relative effectiveness of particular service rules or sets of such rules to identify those service rules that are positively impacting performance and to identify those service rules that do not have a desired impact on reliability. Additionally, the method may include removing, replacing, or modifying those service rules that do not have a desired impact on reliability. The method 40 can include modifying the service rules dependent on other tracked performance metrics of the rules, such as trigger frequency, specificity, selectiveness, or the like.

Additionally, based on the data analysis described above, the method 40 may include predicting a future client demand for servicing of the analyzed component or system. For example, with respect to the IV pump example provided above, the data processing system 34 or a user thereof may calculate an increase or decrease in reliability of the IV pump in proportion to a change in future servicing needs of the IV pump. Particularly, an increase in trend in the reliability of the IV pump may suggest that demand for future servicing of the IV pump will decrease, while a decrease in trend in reliability may be suggest increased demand for servicing of the IV pump in the future. On at least this basis, the data processing system 34 or a user may, as generally indicated in step 52, generate and recommend a certain future resource allocation, such as the number of IV pumps needed in the service provider's inventory, the level of staffing associated with servicing of such a component, or the like.

In one embodiment, the method 40 may also include a step 54 of outputting a report 56 that includes one or more of the following: a trend in the analyzed service event data, a predicted future client demand, and a recommended resource allocation. For instance, one embodiment the report 56 may include an illustration of a recommended resource allocation to implement. Another embodiment of the report 56 may include an illustration of a reliability trend of a device or component. The method 40 may also include predicting a future client demand and allocation of resources dependent on the reported trend generated by the system 10. An embodiment of the step 54 of outputting the report 56 may also include one or more of the following: displaying the report 56 on a display of a computer system, printing the report 56, storing the report 56 for future retrieval, and any other suitable manner that facilitates present or future communication of the information contained in the report 56 to a user.

A technical effect of the subject matter described herein may include, among others, facilitating optimization of service delivery, allowing better prediction of future client needs, and enhancing an efficiency of a client to meet those needs. Additionally, while certain examples are generally discussed above with respect to particular devices or systems, it will be appreciated that the present technique may also find applicability in modeling and predicting service needs on a broader scale, such as for entire departments, facilities, institutions, or even regions. For instance, using the technique described above, one may collect data from one or more healthcare facilities and model trends in the data to predict future demand for one or more resources and to efficiently allocate resources for such demand. More particularly, in one embodiment, patient data may be obtained and modeled to detect a nosocomial outbreak trend in a hospital or region, providing a service provider with an early indication of the outbreak and allowing the provider to allocate resources in a desired manner, based on the detected trend, to treat the outbreak. Additionally, in another embodiment, data related to service delivery quality (e.g., customer complaints) may be analyzed as generally discussed above to detect trends in the quality of service delivery and desired changes (e.g., to resource allocations, training, policies, or the like) may be implemented based on such analysis.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system comprising:
a memory device having a plurality of routines stored therein; and
a processor configured to execute the plurality of routines stored in the one or more memory devices, the plurality of routines comprising:
a routine to collect service event data corresponding to one or more failure modes from a population of medical devices disposed at one or more healthcare facilities;
a routine to analyze the service event data in accordance with a reliability growth model to detect a trend in occurrences of the one or more failure modes; and
a routine to output a report including at least one of the following: an indication of the detected trend, an indication of a predicted future client demand for service of the population of devices attributable to the one or more failure modes based at least in part on the detected trend, or a recommended resource allocation based at least in part on the predicted future client demand.

2. The system of claim 1, wherein the plurality of routines includes a routine to analyze performance of a service rule with respect to at least one of a detection or a prediction of a given failure mode of the one or more failure modes.

3. The system of claim 1, wherein the routine to collect service event data includes at least one of a routine to receive service event data input by an operator, or a routine to obtain service event data from the population of medical devices.

4. The system of claim 1, wherein the routine to output the report includes a routine to store the report in the memory device or in an additional memory device.

5. The system of claim 4, wherein the routine to output the report includes a routine to display the report.

6. A method comprising the steps of:
collecting service event data corresponding to one or more failure modes from a population of devices disposed at one or more client locations;
analyzing the service event data, via a computer, in accordance with a reliability growth model to detect a trend in occurrences of the one or more failure modes;
predicting future client demand for service of the population of devices attributable to the one or more failure modes based at least in part on the detected trend; and
outputting a report including at least one of an indication of the detected trend or an indication of the predicted future client demand.

7. The method of claim 6, wherein the service event data includes a cumulative number of device failures in the population of devices attributable to a particular failure mode of the one or more failure modes, wherein the cumulative number of device failures includes at least one of a predicted device failure or an actual device failure.

8. The method of claim 7, wherein the cumulative number of device failures includes an actual device failure, and the actual device failure of the cumulative number of device failures attributable to the particular failure mode triggers a service rule configured to detect the particular failure mode and generates an indication of an occurrence of the particular failure mode.

9. The method of claim 8, comprising modifying the service rule based at least in part on the frequency with which the service rule is triggered.

10. The method of claim 7, wherein the cumulative number of device failures includes a predicted device failure, and the predicted device failure of the cumulative number of device failures attributable to the particular failure mode is detected via a service rule configured to predict a future occurrence of the particular failure mode.

11. The method of claim 10, further comprising the step of evaluating the efficacy of the service rule based at least in part on the detected trend.

12. The method of claim 11, wherein evaluating the efficacy of the service rule includes comparing a reliability growth of the population of devices before relative to after deployment of the service rule.

13. The method of claim 7, wherein the cumulative number of device failures includes a device failure, and collecting the service event data includes receiving a client notification of the device failure and associating the device failure with the particular failure mode.

14. The method of claim 6, wherein the reliability growth model comprises a Crow-AMSAA model.

15. The method of claim 6, further comprising the step of adjusting an allocation of resources based at least in part on the report.

16. The method of claim 15, wherein the resources include at least one of human resources or replacement parts for the population of devices.

17. The method of claim 6, wherein the step of generating the report includes creating an indication of the detected trend, and wherein the step of predicting future client demand is based at least in part on the output report.

18. A manufacture comprising:
a computer-readable medium having executable instructions stored thereon, the executable instructions comprising:
instructions to collect data from one or more medical facilities;
instructions to analyze the data in accordance with a reliability growth model to detect a trend in the data; and
instructions adapted to output a report including at least one of the following: an indication of the detected trend, an indication of predicted future service demand based at least in part on the detected trend, or a suggested resource allocation based at least in part on the predicted future service demand.

19. The manufacture of claim 18, wherein instructions to output the report include:
instructions to create an indication of the detected trend, and
instructions to predict a future client demand based at least in part on the output report.

20. The manufacture of claim 18, wherein the collected data includes patient data, and the instructions to analyze the data are further adapted to calculate a trend indicative of a nosocomial outbreak in a medical facility.
